(19) United States
(12) Patent Application Publication
(10) Pub. No.: US 2010/0178055 A1
(43) Pub. Date: Jul. 15, 2010

(54) Optical Amplifier with Optical Gain-Control

(76) Inventors: Tomasz Rogowski, Wroclaw (PL); Karin Ennser, Pisa (IT)

Correspondence Address: COATS & BENNETT, PLLC, 1400 Crescent Green, Suite 300, Cary, NC, 27518, US

(21) Appl. No.: 12/063,630

(22) PCT Filed: Aug. 24, 2006
(86) PCT No.: PCT/EP06/65654

§ 371 Date: Jan. 5, 2009

(30) Foreign Application Priority Data
Sep. 1, 2005 (IT) MI2005A 001625

(51) Int. Cl. H04J 14/02; H01S 3/02; H01S 3/106; H04B 10/20

(52) U.S. Cl. 398/59; 359/341.5; 359/341.1; 398/58

(57) ABSTRACT

An optical amplifier with optical gain-control (OGC) has an input (11) for the signals to be amplified and an output (12) for the amplified signals. It comprises in series a first Bragg grating (BG) (15), a variable optical attenuator (VOA) (17), an optical amplification unit with pump (13) and a second Bragg grating (BG) (14). The two gratings define between them a laser cavity with the amplification unit (13) in the middle and the signals to be amplified are placed at the input of the amplification unit (13) with a splitter (16) at the input of the amplification unit. A network with nodes comprising said amplifiers is also described.

This invention relates to an innovative optical amplifier with gain control and to a WDM network with an all optical ring in a metro field using said amplifier.

One problem in ring networks is their sensitivity to accumulating transients because of the saturation of the gain of the amplifiers. In a metro networks market which is very cost sensitive, network designers need control techniques that are flexible and robust and that reduce network complexity and cost. The known main commercial amplifiers in the metro field use electronic gain controls with the disadvantages born from them in terms of cost and performance. An example of electronic gain control solution in reconfigurable Metropolitan Area Networks can be found in N. MADAMOPOULOS ET AL, J. LIGHTWAVE TECHNOL., 20 (2002), P. 937.

As an alternative, Optical Gain Clamping (OGC) can be a simpler technique, relatively economical and efficient has been proposed by M. ZIRNGIBL, Gain control in erbium-doped fiber amplifiers by an all-optical feedback loop, ELECTRON. LETT., 27 (1991), P 560 and G. LUO ET AL, Experimental and Theoretical Analysis of Relaxation-Oscillations and Spectral Hole Burning Effects in All-Optical Gain-Clamped EDFA's for WDM Networks, J. LIGHTWAVE TECHNOL., 16 (1998), P 527. However, the proposed systems for obtaining OGC still suffer however from a not satisfactory robustness to transients unless the cost of the project is raised.

There was proposed recently an Erbium Doped Waveguide Amplifier (EDWA) configuration (K. ENNSER, Control of optical amplifier transient dynamics in metro system network, ICTON (2004), Tu.C1.2). In addition to the superior immunity to transient impairments compared with the Erbium Doped Fiber Amplifier (EDFA), waveguide technology has a good potential for integration with other functions. Said integrated blocks offer a small footprint and low costs in mass production. For the purposes of obtaining an amplifier with OGC, even with the EDWA there remains the problem of finding a configuration satisfying the above-mentioned requirements.

The general purpose of this invention is to make available an innovative all-optical amplifier configuration with optically clamped gain allowing realization of all-optical ring networks while obviating the shortcomings of the prior art.

In view of this purpose it was sought to provide in accordance with this invention an optical amplifier with optical gain-control characterized in that it comprises in series a first Fiber Bragg grating (FBG), a variable optical attenuator (VOA), an optical amplification unit and a second Fiber Bragg grating (BG) with the two gratings having central wavelength such as to define between them a laser cavity with the amplification unit in the middle and the input of the signals to be amplified is between the first grating and the input of the amplification unit.

Again in accordance with this invention it was sought to realize a WDM optical network with ring using said optical amplifiers in the nodes.

To clarify the explanation of the innovative principles of this invention and its advantages compared with the prior art (in U.S. Pat. No. 6,421,168) there is described below with the aid of the annexed drawings a possible embodiment thereof by way of non-limiting example applying said principles. In the drawings:

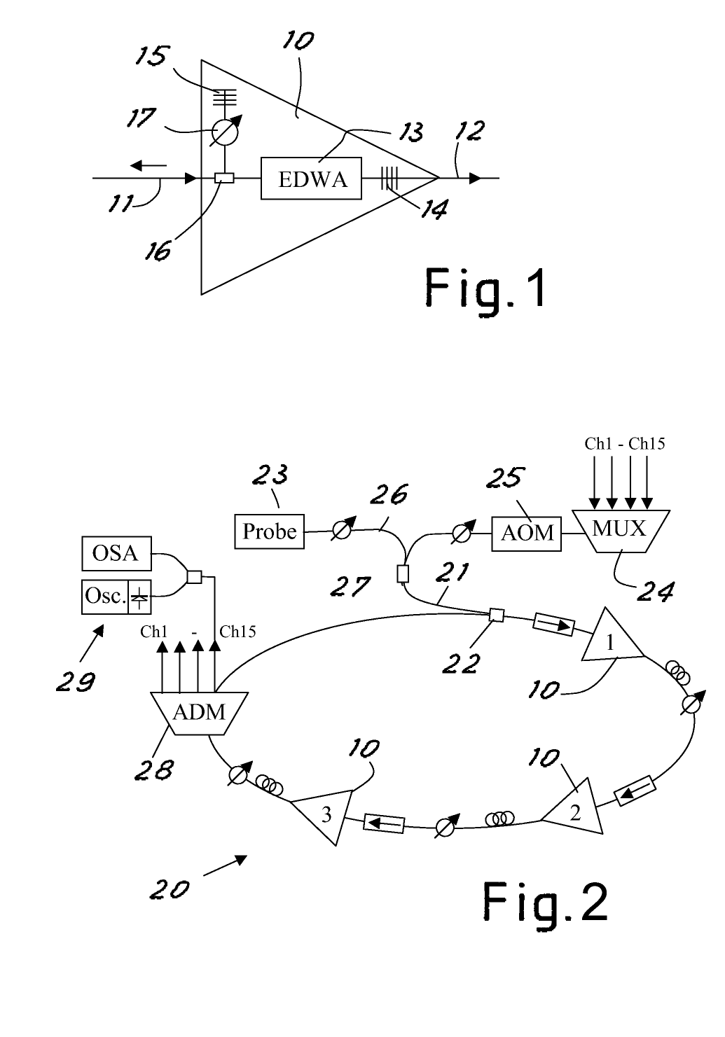

FIG. 1 shows the configuration of an optical gain clamped amplifier configuration realized in accordance with this invention,

FIG. 2 shows an experimental test set-up of a ring network with amplifiers in accordance with this invention, and

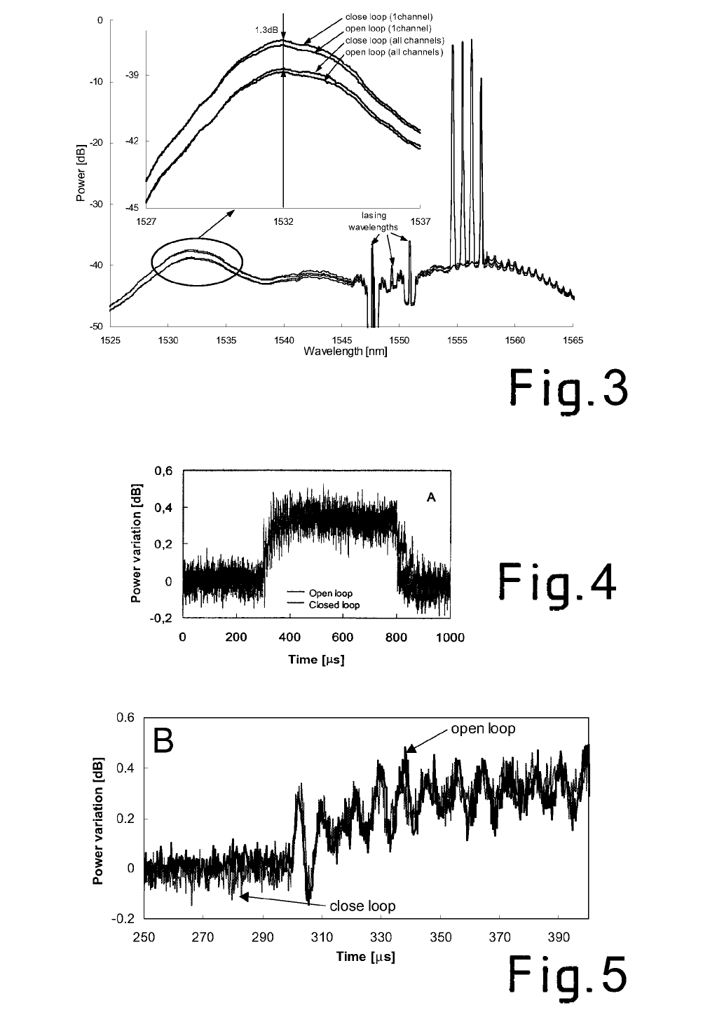

FIGS. 3 to 7 show graphs showing the characteristics of a network using the principles of this invention.

With reference to the figures, FIG. 1 shows diagrammatically the set-up of an amplifier designated as a whole by reference number 10 with clamped optical gain in accordance with this invention and with one input 11 and one output 12. The amplifier contains a gain block 13 made up of a known amplifier and in particular with a pump. Said pump amplifier can be advantageously realized with a known Erbium Doped Waveguide Amplifier (EDWA). This allows better performance in the transients. However, with the principles of this invention a known Erbium Doped Fiber Amplifier (EDFA) was also found usable.

The laser cavity is made up of two known Fiber Bragg Gratings (FBG) 14, 15 between which is arranged the amplifier unit 13. The length of the cavity is therefore the total path between the two gratings. However with the principles of this invention the FBGs mentioned above can be also drawn in the integrated waveguide structure.

The two gratings are chosen with central wavelength such as to form the laser cavity by using the amplifier unit as the active medium. For example, the central wavelength is placed at 1549.58 nm (WDM C-band). Even if there are no transmission signals at the amplifier input, the noise generated by the pumped amplifier is reflected between the two gratings on the central length of these pass-band filters until obtaining sufficient power to effect laser action at this wavelength.

The FBG 14 is advantageously a “flat top” grating with 0.2 nm to 1 nm full-width-half-maximum (FWHM), high reflection factor (advantageously more than 95% and in particular around 99.9%) and is placed in line with the signal channels. The FBG 15 has the FWHM band (also with central wavelength equal to that of the FBG 14) in the example of 0.2 nm and with a reflection factor that can be lower than that of the first FBG (for example advantageously higher than 80% and in particular around 95% or higher). The grating 15 is advantageously of the “narrow top” 0.2 nm full-width-half-maximum type.

The signal channels that reach the input 11 enter into the EDWA 13 through a splitter 16 that on the other port connects the second FBG 15 to the EDWA through a known Variable Optical Attenuator (VOA) 17. The splitter is advantageously a 90%/10% splitter (loss 0.5 dB).

In other words, the amplifier is made up of a series of a first grating, a VOA, the pump amplification unit and the other grating. The signals to be amplified are inserted between VOA and the input of the amplification unit while the output signals are taken at the amplification unit output through the other grating.

Insertion of the VOA 17 allows to flexibly controlling of the gain clamping. This feature will be useful for example in case the network topology and its losses are reconfigured.

It was found extremely advantageous to apply this configuration to a re-circulating all-optical WDM ring network.

In this network it must be avoided that the laser power might return to the cavity through the recirculation. For this reason, the inputs and outputs of the amplifier and the gratings are placed in such a manner as to allow the laser power to go out only in the backward direction. In the forward direction the laser power is stopped instead by the in-line isolator while the power loss of the laser co-propagating through the mirror at 99.9% will be negligible and a coupling power under 100 nW can be estimated.

In the example, the cavity is set at a gain of 13 dB and pump power is 180 mW. Considering that the unclamped amplification condition is obtained with approximately 160 mW of pump power, it is seen that only 15% of extra pump power is necessary to obtain steady clamping and immunity to transients.

It was also found that another increase in pump power up to a saturation level reduces the power overshoot still more.

It was also found that an OGC-EDWA with a cavity 1 m long will have better performance than a longer OGC-EDFA cavity (10 m or more) because of shorter relaxation time of the laser cavity allowing a faster recovery from transients. The performance of the amplifier with OGC in accordance with this invention can therefore be easily improved by optimizing the cavity length and in particular in the case of OGC-EDWA.

FIG. 2 shows the experimental layout of a ring network 20 in a closed metro field with three nodes. Each node comprises an amplifier 10 of FIG. 1 in accordance with this invention. In particular the version with EDWA was chosen with the gain of the EDWA of approximately 12 dB to 13 dB in the saturation regime.

The pump powers in the three nodes are respectively 200 mW, 180 mW and 180 mW. The central wavelengths are respectively 1549.58 nm, 1551.18 nm and 1547.98 nm. A cavity length of the OGC-EDWA of 9 m is used intentionally for the purpose of extending the validity of the results even with networks based on OGC-EDFA.

To verify the performance of the system, test channels are introduced before the first node and removed after the last node.

To obtain 16 WDM channels to be inserted in 21 (by means of an appropriate 50/50 coupler designated by reference number 22) 3 channels of −7 dBm each are introduced to simulate each one five transmission channels with power five times the power of the channel 16 (5×ch 16) and one probe signal (ch 16) 26 of −14 dB produced at 23 for a total input power of −2 dBm before the first node. Four DFB lasers not shown are spaced by 100 GHz one from the other starting from 1554.95 nm.

The 15 simulated channels are multiplexed by a known MUX 24 and are switched on and off by an Acoustic Optic Modulator (AOM) 25 with a repetition frequency of 1 KHz before being combined with the probe channel 26 by means of a 50/50 coupler 27. VOAs can be used to attenuate the channels.

It is assumed that no channel circulates more than once, contrary to the ASE noise and the wavelengths of the lasers used to clamp each amplifier. Each section has approximately 12 dB of span loss. Naturally, the figures are given here as examples and can vary in the real applications.

All of the channels are extracted by a known demultiplexer and sent to a block of instruments 29 to verify the robustness of the solution.

FIG. 3 shows the optical spectrum of the open and closed ring network with the load of one channel or of all the channels. The enlargement shows a detail of the differences between open ring and closed ring. It can be seen that the open and closed ring spectra are very similar to each other. It can therefore be concluded that the recirculating ASE light has a small impact in the closed ring and that the clamped amplifiers act independently. A small shift can be seen between the two scenarios because of the SHB effect that mainly dominates the region at 1533 nm; the variation of 1.3 dB must be noted. The ripples on the left side are due to the DBF probe laser. However if the central wavelengths of the gratings are the same for each amplifier in the network almost the full C-band is available for WDM transmission.

FIG. 4 illustrates the power excursion of the surviving channel after adding and dropping of 15 out of 16 channels for the longest optical path in order to simulate the worst scenario. To quantify the impact of the ASE noise accumulated in the closed ring the open ring configuration is also measured. However, no significant change in the transients is observed.

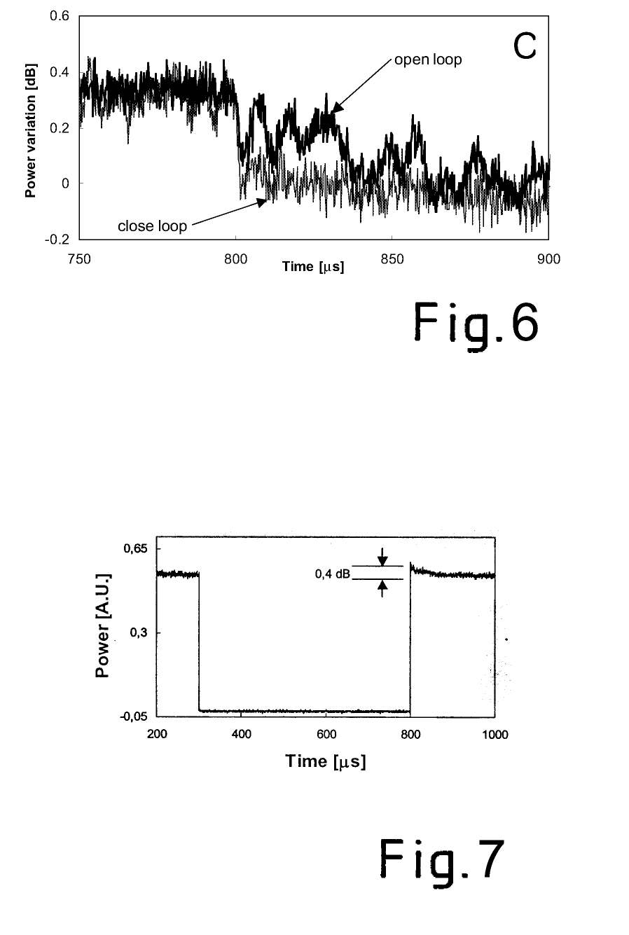

For reasons of clarity, FIGS. 5 and 6 show the transients enlargement at adding and dropping operation of FIG. 4. The small SHB shift observed after the dropping of 15 channels is due to in band lasing.

It should be noted that the maximum overshoot of approximately 0.25 dB and the SHB shift of 0.4 dB are caused just by the linear sum of the effects of the three OGC-EDWA concatenation. The maximum overshoot measured and the SHB shift for a single OGC-EDWA are approximately 0.08 dB and 0.14 dB respectively. This confirms that each amplifier with OGC of this invention acts independently and that the results can be handled in N stages with any N.

Independent control of the amplifier gain realized in accordance with this invention makes the network robust against accumulation of recovery or failure transients. The network failure can be due to a degradation of components or the cutting of the fiber.

For example, FIG. 7 shows the effect of an abrupt interruption of all the channels with subsequent recovery. As may be seen in the figure, at the beginning of the network recovery, transient peaks of 0.4 dB and then a rapid stabilization of the system are observed. It is noted that this overshoot peak is equal to the SHB offset of FIG. 4 showing that in case of failure there is no other extra effect than a simple dropping of channels.

It is now clear that the preset purposes have been achieved by design an all optical amplifier with OGC with robust characteristics even if relatively simple and not costly. Dynamic regulation of amplifier's gain is easily obtainable by setting a simple VOA.

It was also shown how to realize a robust, scalable, flexible low cost all-optical WDM ring network based on said amplifiers with optically clamped gain. The robustness of the ring network in case of adding and dropping of channels and of failure of the network is shown both in the open and closed ring configurations. As the amplifiers in accordance with this invention are clamped individually, significantly fast response times and high robustness of transients are obtained. The experimental results show that almost the full C-band is available for the transmission WDM channels. In addition, the results obtained are scalable when the number of nodes is increased. The scalability of the network in accordance with this invention to N sections is thus proven.

The fact that the network project proposed is merely based on standard elements allows easy updating of the network. For example it is conceivable that the excellent performance of the solution in accordance with this invention be suited to the next generation of WDM installed ring networks.

Naturally the above description of an embodiment applying the innovative principles of this invention is given by way of non-limiting example of said principles within the scope of the exclusive right claimed here. The amplifier in accordance with this invention can be advantageously used even in point-to-point systems, in mesh networks and in ring configurations as well. Although the principles of this invention are particularly useful in a metro network said principles can also be applied in long-distance or other networks; it suffices that there be need of an amplifier in saturated operation.

1-15. (canceled)

16. An optical amplifier with optical gain-control comprising:
first and second Fiber Bragg gratings having a central wavelength and defining a laser cavity between them;
an optical amplification unit disposed in the laser cavity between the first and second Fiber Bragg gratings;
an optical signal input disposed between the first Fiber Bragg grating and an input of the amplification unit to receive optical signals to be amplified.

17. The optical amplifier of claim 16 further comprising a variable optical attenuator disposed between the first and second Fiber Bragg gratings.

18. The optical amplifier of claim 16 wherein the amplification unit comprises an Erbium Doped Waveguide Amplifier (E(Y)DWA) or an Erbium Doped Fiber Amplifier (E(Y)DFA).

19. The optical amplifier of claim 16 wherein the second Fiber Bragg grating is disposed at an output of the optical amplification unit, and processes signals amplified by the optical amplifier.

20. The optical amplifier of claim 16 further comprising a coupling splitter disposed between variable optical attenuator and the optical amplification unit, and wherein transmission signals to be amplified are received at the optical amplification unit via the coupling splitter.

21. The optical amplifier of claim 20 wherein the coupling splitter comprises a 90%/10% coupling splitter.

22. The optical amplifier of claim 19 wherein the second Fiber Bragg grating comprises a “flat top” 0.2-nm to 1-nm full-width-half-maximum (FWHM) type grating.

23. The optical amplifier of claim 16 wherein the first Fiber Bragg grating comprises a “narrow top” 0.2-nm full-width-half-maximum (FWHM) type grating.

24. The optical amplifier of claim 16 wherein the first Fiber Bragg grating has a reflecting power greater than about 80%.

25. The optical amplifier of claim 24 wherein the first Fiber Bragg grating has a reflecting power greater than or equal to about 95%.

26. The optical amplifier of claim 16 wherein the second Fiber Bragg grating has a reflecting power greater than about 95%.

27. The optical amplifier of claim 26 wherein the second Fiber Bragg grating has a reflecting power of about 99.9%.

28. An optical telecommunication network comprising one or more nodes, each of the one or more nodes including an optical amplifier with optical gain-control comprising:
first and second Fiber Bragg gratings having a central wavelength and defining a laser cavity between them;
an optical amplification unit disposed in the laser cavity between the first and second Fiber Bragg gratings; and
an optical signal input disposed between the first Fiber Bragg grating and an input of the amplification unit to receive optical signals to be amplified.

29. The network of claim 28 wherein each node further comprises a variable optical attenuator disposed between the first and second Fiber Bragg gratings.

30. The network of claim 28 wherein the optical telecommunication network comprises an all-optical Wavelength Division Mulitplexing (WDM) ring network.

31. The network of claim 30 wherein the optical telecommunication network further includes amplified spontaneous emission (ASE) light recirculation.

32. The network of claim 28 wherein the optical telecommunication network comprises a point-to-point, mesh network.

33. The network of claim 32 wherein the optical telecommunication network comprises a metropolitan network.
